(19) United States
(12) Patent Application Publication
(10) Pub. No.: US 2022/0189503 A1
(43) Pub. Date: Jun. 16, 2022

(54) METHODS, SYSTEMS, AND COMPUTER PROGRAM PRODUCTS FOR DETERMINING WHEN TWO PEOPLE ARE TALKING IN AN AUDIO RECORDING

(71) Applicant: Liine, LLC, 27609, NC (US)

(72) Inventors: Bradley Blaser, Raleigh, NC (US); Andrew Johnson, Raleigh, NC (US)

(21) Appl. No.: 17/644,159

(22) Filed: Dec. 14, 2021

Related U.S. Application Data
(60) Provisional application No. 63/125,090, filed on Dec. 14, 2020.

(51) Int. Cl. G10L 25/78; G10L 25/93; G10L 25/30; G10L 21/10; G06N 3/04

(52) U.S. Cl. CPC G10L 25/78; G10L 25/93; G06N 3/0481; G10L 21/10; G10L 25/30

(57) ABSTRACT

A method includes receiving an audio file that includes a recording comprising one or more first intervals in which a plurality of persons is engaged in conversation and one or more second intervals in which the plurality of persons are not engaged in conversation; and determining, using an artificial intelligence engine, a temporal arrangement of the one or more first intervals with the one or more second intervals.

### RELATED APPLICATION

The present application claims priority from and the benefit of U.S. Provisional Application No. 63/125,090, filed Dec. 14, 2020, the disclosure of which is hereby incorporated herein by reference in its entirety.

### FIELD

The present inventive concepts relate generally to artificial intelligence systems and, more particularly, to the use of artificial intelligence in analyzing an audio recording.

### BACKGROUND

Audio recordings may be analyzed for a variety of different applications. For example, audio forensics is a field of forensic science relating to the acquisition, analysis, and evaluation of sound recordings that may ultimately be presented as admissible evidence in a court of law or some other official venue. Businesses often record calls from customers or potential customers to ensure the interactions comply with company policies and procedures as well as to evaluate the content and patterns of the interactions. Such an analysis may be used, for example, to identify behaviors that may increase sales, appointments, reservations, and/or interest in the business. An audio recording, however, may be difficult to analyze due to the various types of sounds that may be recorded. For example, in addition to periods where a caller is engaged in conversation with another party, a caller may be put on hold and may receive recorded music and/or recorded announcements. There may also be periods of silence or periods where extraneous noise is recorded from either the caller's end of the call or the called party's end of the call. The variety of different sources of audio in an audio recording may make it difficult to identify more high value portions of the recording where two persons are engaged in conversation.

### SUMMARY

According to some embodiments of the inventive concept, a method comprises: receiving an audio file that includes a recording comprising one or more first intervals in which a plurality of persons is engaged in conversation and one or more second intervals in which the plurality of persons are not engaged in conversation; and determining, using an artificial intelligence engine, a temporal arrangement of the one or more first intervals with the one or more second intervals.

In other embodiments, each of the one or more first intervals is categorized as a first interval type; and each of the one or more second intervals is categorized as one of a plurality of second interval types.

In still other embodiments, the first interval type comprises a human speech interval; and the plurality of second interval types comprises a silence interval, a music interval, and a music and human speech combined interval.

In still other embodiments, determining the temporal arrangement of the one or more first intervals with the one or more second intervals comprises: determining, using the artificial intelligence engine, the temporal arrangement of the one or more first intervals with the one or more second intervals by category. The method further comprising: reporting the temporal arrangement of the one or more first intervals with the one or more second intervals by category.

In still other embodiments, the method further comprises: determining a portion of the audio file that is categorized as the human speech interval; determining a portion of the audio file that is categorized as the silence interval; determining a portion of the audio file that is categorized as the music interval; and/or determining a portion of the audio file that is categorized as the music and human speech combined interval.

In still other embodiments, determining, using the artificial intelligence engine, the temporal arrangement of the one or more first intervals with the one or more second intervals comprises: splitting the audio file into a plurality of channel files respectively corresponding to the plurality of persons engaged in conversation; temporally splitting each of the plurality of channel files into a plurality of time segment channel files; and generating, for each of the plurality of time segment channel files, a corresponding two-dimensional input array.

In still other embodiments, the corresponding two-dimensional input array comprises a spectrogram of a respective one of the plurality of time segment channel files.

In still other embodiments, the corresponding two-dimensional input array comprises a representation of an image of a spectrogram of a respective one of the plurality of time segment channel files.

In still other embodiments, the artificial intelligence engine comprises a multi-layer artificial neural network including an input layer, a plurality of hidden layers, and an output layer, the method further comprising: receiving, for each of the plurality of time segment channel files, the corresponding two-dimensional input array at the input layer; processing, for each of the plurality of time segment channel files, the corresponding two-dimensional input array using the plurality of hidden layers; and generating, for the plurality of time segment channel files, a plurality of output arrays, respectively, using the output layer.

In still other embodiments, the plurality of hidden layers comprises at least one convolution layer, at least one max pooling layer, at least one flatten layer, and at least one densely connected layer.

In still other embodiments, the at least one convolution layer uses a Rectified Linear Unit (ReLU) activation function and the at least one densely connected layer uses a ReLU activation function or a Softmax activation function.

In still other embodiments, each of the plurality of output arrays comprises a probability value for each of the first interval type and the plurality of second interval types occurring during a respective one of the plurality of time segment channel files.

In still other embodiments, determining, using the artificial intelligence engine, the temporal arrangement of the one or more first intervals with the one or more second intervals by category comprises: combining the plurality of output arrays corresponding to each of the plurality of time segment channel files across the plurality of channel files to generate a final output array containing probability values for each of the first interval type and the plurality of second interval types occurring during time intervals respectively corresponding to the plurality of time segment channel files; filtering the probability values in the final output array; and using the filtered probability values in the final output array to determine the temporal arrangement of the one or more first intervals with the one or more second intervals by category.

In some embodiments of the inventive concept, a system comprises a processor; and a memory coupled to the processor and comprising computer readable program code embodied in the memory that is executable by the processor to perform operations comprising: receiving an audio file that includes a recording comprising one or more first intervals in which a plurality of persons is engaged in conversation and one or more second intervals in which the plurality of persons are not engaged in conversation; and determining, using an artificial intelligence engine, a temporal arrangement of the one or more first intervals with the one or more second intervals.

In further embodiments, each of the one or more first intervals is categorized as a first interval type; and each of the one or more second intervals is categorized as one of a plurality of second interval types.

In still further embodiments, the first interval type comprises a human speech interval; and the plurality of second interval types comprises a silence interval, a music interval, and a music and human speech combined interval.

In still further embodiments, determining the temporal arrangement of the one or more first intervals with the one or more second intervals comprises: determining, using the artificial intelligence engine, the temporal arrangement of the one or more first intervals with the one or more second intervals by category. The operations further comprising: reporting the temporal arrangement of the one or more first intervals with the one or more second intervals by category.

In some embodiments, a computer program product comprises a non-transitory computer readable storage medium comprising computer readable program code embodied in the medium that is executable by a processor to perform operations comprising: receiving an audio file that includes a recording comprising one or more first intervals in which a plurality of persons is engaged in conversation and one or more second intervals in which the plurality of persons are not engaged in conversation; and determining, using an artificial intelligence engine, a temporal arrangement of the one or more first intervals with the one or more second intervals.

In other embodiments, each of the one or more first intervals is categorized as a first interval type; and each of the one or more second intervals is categorized as one of a plurality of second interval types.

In still other embodiments, the first interval type comprises a human speech interval; the plurality of second interval types comprises a silence interval, a music interval, and a music and human speech combined interval; and determining the temporal arrangement of the one or more first intervals with the one or more second intervals comprises: determining, using the artificial intelligence engine, the temporal arrangement of the one or more first intervals with the one or more second intervals by category. The operations further comprising: reporting the temporal arrangement of the one or more first intervals with the one or more second intervals by category.

Other methods, systems, articles of manufacture, and/or computer program products according to embodiments of the inventive concept will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims. It is further intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram that illustrates a communication network including an Artificial Intelligence (AI) assisted audio recording analysis system for determining when two people are talking in accordance with some embodiments of the inventive concept;

FIG. 2 is a block diagram of the AI assisted audio recording analysis system of FIG. 1 in accordance with some embodiments of the inventive concept;

FIG. 3 is a diagram of an artificial neural network of FIG. 2 according to some embodiments of the inventive concept;

FIGS. 4-7 are flowcharts that illustrate operations of the AI assisted audio recording analysis system of FIG. 1 according to some embodiments of the inventive concept;

FIG. 8 is a data processing system that may be used to implement one or more servers in the AI assisted audio recording analysis system of FIG. 1 in accordance with some embodiments of the inventive concept; and

FIG. 9 is a block diagram that illustrates a software/hardware architecture for use in the AI assisted audio recording analysis system of FIG. 1 in accordance with some embodiments of the inventive concept.

### DETAILED DESCRIPTION

In the following detailed description, numerous specific details are set forth to provide a thorough understanding of embodiments of the present inventive concept. However, it will be understood by those skilled in the art that the present invention may be practiced without these specific details. In some instances, well-known methods, procedures, components, and circuits have not been described in detail so as not to obscure the present inventive concept. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

Embodiments of the inventive concept are described herein in the context of an artificial intelligence engine comprising a multi-layer neural network. It will be understood that other types of artificial intelligence systems can be used in other embodiments of the artificial intelligence engine including, but not limited to, machine learning systems, deep learning systems, and/or computer vision systems. Moreover, it will be understood that the multi-layer neural network described herein is a multi-layer artificial neural network comprising artificial neurons or nodes and does not include a biological neural network comprising real biological neurons.

Some embodiments of the inventive concept stem from a realization that due to the variety of sources of audio in an audio recording, it may be difficult to identify more high value portions of the recording where, for example, two or more persons are engaged on conversation. Some embodiments of the inventive concept may provide an Artificial Intelligence (AI) assisted audio recording analysis system in which an AI engine is used to process an audio recording that includes one or more first intervals in which a plurality of persons are engaged in conversation and one or more second intervals in which the plurality of persons are not engaged in conversation. The AI engine may be used to determine a temporal arrangement of the one or more first intervals with the one or more second intervals. In some embodiments, the first intervals may be categorized as a first interval type, e.g., a human speech interval. Multiple category types may be used to categorize the second intervals. For example, in some embodiments, the second interval types may include, but are not limited to, a silence interval, a music interval, and a music and human speech combined interval. The music and human speech combined interval type may include examples in which the human speech is an automated recording, which may include background music or sound. The identification of the various demarcation times dividing the various intervals during the audio recording including identification of the interval types may be reported to one or more users in a variety of ways including, but not limited to, on a display, by message, including email and/or text message, recorded in an accessible output file, and the like.

Thus, the AI engine may be used to determine the temporal arrangement of the one or more first intervals with the one or more second intervals by category. Moreover, the AI engine may be used to determine a portion of the audio file that is categorized as a human speech interval, a portion that of the audio file that is categorized as a silence interval, a portion of the audio file that is categorized as a music interval, and/or a portion of the audio file that is categorized as a music and human speech combined interval. The AI assisted audio recording analysis system may, therefore, provide metrics with respect to the amounts of time in the recording that are associated with various categories along with the start and stop times of the various intervals associated with those categories. In a non-limiting example, the second interval types that comprise a silence interval, a music interval, and a music and human speech combined interval, may be characterized as “hold time” when the humans in the recording are not speaking. The humans in this non-limiting example may be represented by one or more callers and one or more human agents.

In processing the audio file recording, the initial audio file may be split into multiple channel files corresponding to the plurality of persons engaged in conversation on the recording. Each of these channel files may be temporally split into a plurality of time segment channel files. The temporal split may be based on the level of granularity desired in analyzing the recording. For example, a 2-second segment may be chosen, such that each of the plurality of time segment channel files corresponds to a 2-second portion of one channel of the audio recording. A two-dimensional input array may be generated for each of the plurality of time segment channel files. In accordance with various embodiments of the inventive concept, the two-dimensional input array may comprise a spectrogram or may be a representation of an image of a spectrogram.

The processing may be performed by a sequential machine learning model that is incarnated as an AI engine. The two-dimensional input arrays may each be processed by an AI engine that includes an artificial neural network. The artificial neural network may comprise one or more convolution layers, at least one max pooling layer, at least one flatten layer, and at least one densely connected layer. The one or more convolution layers may use a Rectified Linear Unit (ReLU) activation function and the one or more densely connected layers may use a ReLU activation function or a Softmax activation function

The artificial neural network may generate output arrays that comprise a probability value for each of the first interval type and the plurality of second interval types occurring during respective ones of the time segment channel files. These output arrays corresponding to each of the time segment channel files may be combined across the plurality of channel files to generate a final output array containing probability values for each of the first interval type and the plurality of second interval types occurring during time intervals corresponding to the plurality of time segment channel files. The probability values in the final output array may be filtered to reduce the effects of noise and to smooth the results and these filtered probability values may be used to determine the temporal arrangement of the one or more first intervals corresponding to two or more persons engaged in conversation with one or more second intervals in which two or more persons are not engaged in conversation by category.

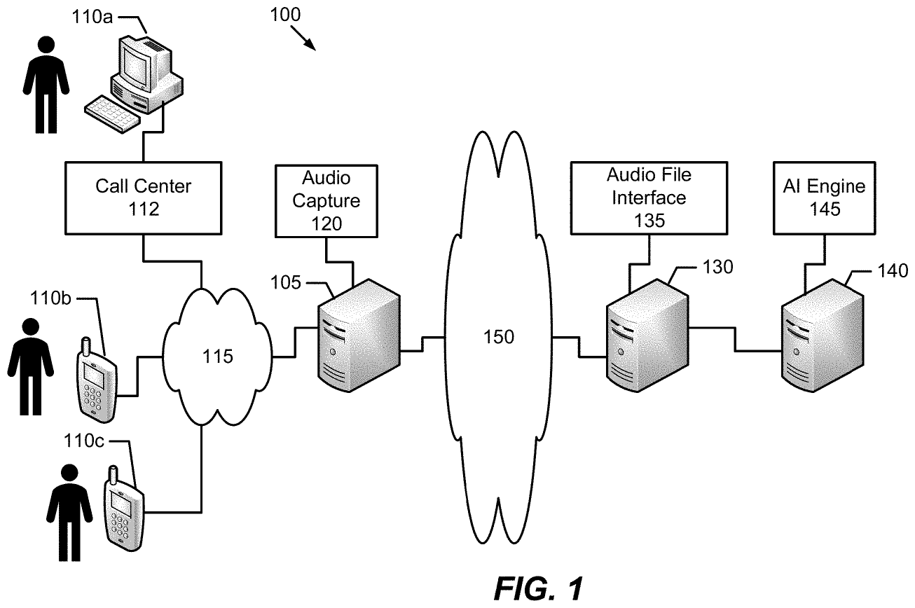

Referring to FIG. 1, a communication network 100 including an AI assisted audio recording analysis system for determining when two people are talking, in accordance with some embodiments of the inventive concept, comprises a recording server 105 including an audio capture module 120. A network communicatively couples one or more persons associated with devices 110b and 110c to a call center 112, which is staffed via a person using device 110a. Although a call center example is illustrated in FIG. 1, it will be understood that embodiments of the inventive concept are applicable to any environment in which at least two persons may engage in a conversation and that conversation is subject to recording. The audio capture module 120 may be configured to generate audio files by recording calls between the persons associated with devices 110b and 110c and a person associated with device 110a.

According to some embodiments of the inventive concept, audio files recorded using the audio capture module 120 may be communicated to an AI assisted audio recording analysis system, which may comprise an interface server 130 including an audio file interface module 135 and an AI server 140 including an AI engine module 145. The interface server 130 may be configured to receive the audio file from the recording server 105 and may cooperate with the AI server 140 to analyze the audio file to determine a temporal arrangement of one or more first intervals in which persons are engaged in conversation and one or more second intervals in which persons are not engaged in conversation in accordance with embodiments of the inventive concept.

It will be understood that the division of functionality described herein between the AI server 140/AI engine module 145 and the interface server 130/audio file interface module 135 is an example. Various functionality and capabilities can be moved between the AI server 140/AI engine module 145 and the interface server 130/audio file interface module 135 in accordance with different embodiments of the inventive concept. Moreover, in some embodiments, the AI server 140/AI engine module 145 and the interface server 130/audio file interface module 135 may be merged as a single logical and/or physical entity.

A network 150 couples the recording server 105 to the interface server 130 and the network 115 couples the devices 110b and 110c to the call center 112/device 110a. The networks 115 and 150 may each be a global network, such as the Internet, Public Switched Telephone Network (PSTN), or other publicly accessible network. Various elements of the networks 115, 150 may be interconnected by a wide area network, a local area network, an Intranet, and/or other private network, which may not be accessible by the general public. Thus, the communication networks 115, 150 may represent a combination of public and private networks or a virtual private network (VPN). The networks 115, 150 may be a wireless network, a wireline network, or may be a combination of both wireless and wireline networks.

The service provided through the AI server 140/AI engine module 145 and the interface server 130/audio file interface module 135 to provide an AI assisted audio recording analysis to determine when two people are talking may, in some embodiments, be embodied as a cloud service. For example, the recording server 105 and audio capture module 120 may be configured to access the AI assisted audio recording analysis service as a Web service. In some embodiments, the AI assisted audio recording analysis service may be implemented as a Representational State Transfer Web Service (RESTful Web service).

Although FIG. 1 illustrates an example communication network including an AI assisted audio recording analysis system to determine when two people are talking, it will be understood that embodiments of the inventive concept are not limited to such configurations, but are intended to encompass any configuration capable of carrying out the operations described herein.

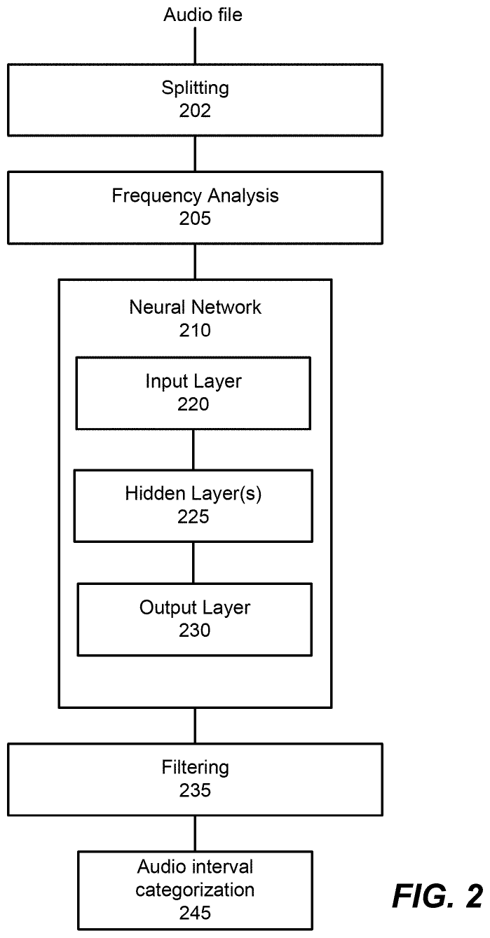

FIG. 2 is a functional block diagram of the AI assisted audio recording analysis system of FIG. 1 comprising the AI server 140/AI engine module 145 and the interface server 130/audio file interface module 135. As shown in FIG. 2, AI assisted audio recording analysis system includes a splitting module 202, a frequency analysis module 205, an artificial neural network 210, a filtering module 235, and an audio interval categorization module 245. The splitting module 202 may be configured to receive the audio file from the recording server 105 and split the audio file into multiple channel files corresponding to the plurality of persons engaged in conversation on the recording. These channel files may be further temporally split into a plurality of time segment channel files, which may be based on a level of granularity desired in analyzing the recording. In some embodiments, a 2-second segment may be used, such that each of the plurality of time segment channel files corresponds to a 2-second portion of one channel of the audio recording. The remaining portion of a channel file may be padded with silence so each time segment channel file corresponds to the same time duration interval, e.g., 2-seconds

The frequency analysis module 205 may be used to generate a two-dimensional input array for each of the plurality of time segment channel files. In accordance with various embodiments of the inventive concept, the two-dimensional input array may comprise a spectrogram or may be a representation of an image of a spectrogram. For example, a spectrogram may be created with a sampling frequency of 8000 samples/second, a Tukey window with a shape parameter of 0.25, and a Fast Fourier Transform (FFT) length and segment length of 300 with an overlap of 200, which results in a two-dimensional array with a shape of (151,158). In other embodiments, the two-dimensional array may comprise a representation of an image of a spectrogram with a window length of 8000 samples/second, an FFT length of 128, a segment length of 8000, and an overlap of 127, which results in a two-dimensional array with a shape of (288, 432). The RGB image of the spectrogram may be converted into a grayscale image, which may then be converted into a two-dimensional array of the spectrogram image.

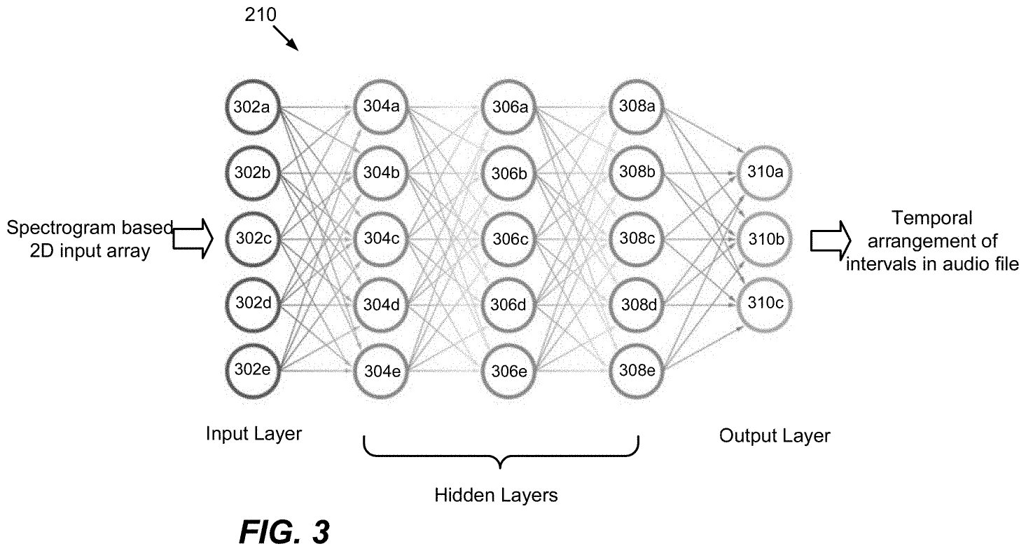

The neural network module 210 may be configured to receive the two-dimensional input arrays at an input layer 220 for processing. The neural network 210 includes the input layer 220, one or more hidden layers 225, and an output layer 230. The neural network 210 is shown in more detail in FIG. 3. Referring now to FIG. 3, artificial neural networks are generally based on the same fundamental concepts. The data to be analyzed is broken into elements that can be distributed across an array of nodes, e.g., pixels for an image-recognition task or parameters for a forecasting problem. The artificial neural network 210 may consist of two or more layers of nodes, which can be connected to each other in a variety of different ways.

In a fully connected layer, every node in layer A connects to every node in layer B. In a convolutional layer, in contrast, a filter is defined that assigns a small portion of layer A to each node in layer B. In the example where layers A and B are fully or densely connected, each node in layer A sends its data element to each node in layer B. In the example of FIG. 3, each of the layers is fully or densely connected, but this is merely an example. In other embodiments, only a portion of the artificial neural network 210 layers may be fully or densely connected. Each node in layer B multiplies each of the data elements received from the layer A nodes by a respective weight that corresponds to the layer A node from which the data element was received and then sums these products for all of the nodes in layer A. Each node in layer B may then apply an activation function to the summation and forward the output on to the nodes in the next layer. The process repeats for as many layers as there are in the artificial neural network 210.

In the example of FIG. 3, the artificial neural network 210 includes a plurality of node layers comprising an input layer, one or more hidden layers, and an output layer. In the example shown in FIG. 3, an input layer comprises five nodes or neurons 302a, 302b, 302c, 302d, and 302e and an output layer comprises three nodes or neurons 310a, 310b, and 310c. In the example shown, three hidden layers connect the input layer to the output layer including a first hidden layer comprising five nodes or neurons 304a, 304b, 304c, 304d, and 304e, a second hidden layer comprising five nodes or neurons 306a, 306b, 306c, 306d, and 306e, and a third hidden layer comprising five nodes or neurons 308a, 308b, 308c, 308d, and 308e. Other embodiments may use more or fewer hidden layers. Each node or neuron connects to another and has an associated weight and threshold. If the output of any individual node or neuron is above the specified threshold value, that node is activated, sending data to the next layer of the network. Otherwise, no data is passed along to the next layer of the network.

The artificial neural network 210 relies on training data to learn and improve its accuracy over time. Once the various parameters of the neural network system 210 are tuned and refined for accuracy, it can be used, among other applications, to process audio files to temporally categorize the various intervals at the output layer 230 including identifying those intervals where two persons are engaged in conversation and identifying intervals when two persons are not engaged in conversation and other activities are taking place such as silence, music, music and human speech, and the like.

Each individual node or neuron may be viewed as implementing a linear regression model, which is composed of input data, weights, a bias (or threshold), and an output. Once an input layer is determined, weights are assigned. These weights help determine the importance of any given variable, with larger ones contributing more significantly to the output compared to other inputs. All inputs are then multiplied by their respective weights and then summed, i.e., a MAC operation. In FIG. 3, node or neuron 306a, for example, receives inputs corresponding to the outputs of nodes or neurons 304a, 304b, 304c, 304d, and 304e. These inputs are multiplied by their corresponding weights and summed at node or neuron 306a. Afterward, the output is passed through an activation function, which determines the output. If that output exceeds a given threshold, it activates the node by passing data to the next layer in the network. This results in the output of one node becoming in the input of the next node. This process of passing data from one layer to the next layer is an example of a feedforward artificial neural network.

In accordance with some embodiments of the inventive concept, the artificial neural network 210 may comprise hidden layers 225 including a two-dimensional convolution layer with 64 filters and a kernel size of 3, a two-dimensional max pooling layer with a pool size of (2,2), two-dimensional convolution layer with 128 filters and a kernel size of 3, a two-dimensional max pooling layer with a pool size of (2,2), a two-dimensional convolution layer with 64 filters and a kernel size of 3, a two-dimensional max pooling layer with a pool size of (2,2), a flatten layer, a densely connected neural network with 64 layers using a ReLU activation function, and a densely connected neural network with 4 layers and using a Softmax activation function, which are sequentially arranged. The convolution layers may use a ReLU activation function.

As described above, the artificial neural network may generate output arrays that comprise a probability value (e.g., a value ranging from 0-1 with 1 representing 100% probability) for each of the first interval type and the plurality of second interval types occurring during respective one of the time segment channel files. These output arrays corresponding to respective ones of the time segment channel files may be combined across the plurality of channel files to generate a final output array containing probability values for each of the first interval type and the plurality of second interval types occurring during time intervals corresponding to the plurality of time segment channel files. The filtering module 235 may be configured to filter the probability values in the final output array using a median filter to reduce the effects of noise and to smooth the results. A high pass filter may be used to clamp each probability value to 1 (e.g., 100%) if the probability value is above a defined threshold. A median filter may be used to further reduce the effects of noise and to smooth the results.

The audio interval categorization module 245 may be configured to use these filtered probability values to determine the temporal arrangement of the one or more first intervals corresponding to two or more persons engaged in conversation with one or more second intervals in which two or more persons are not engaged in conversation by category.

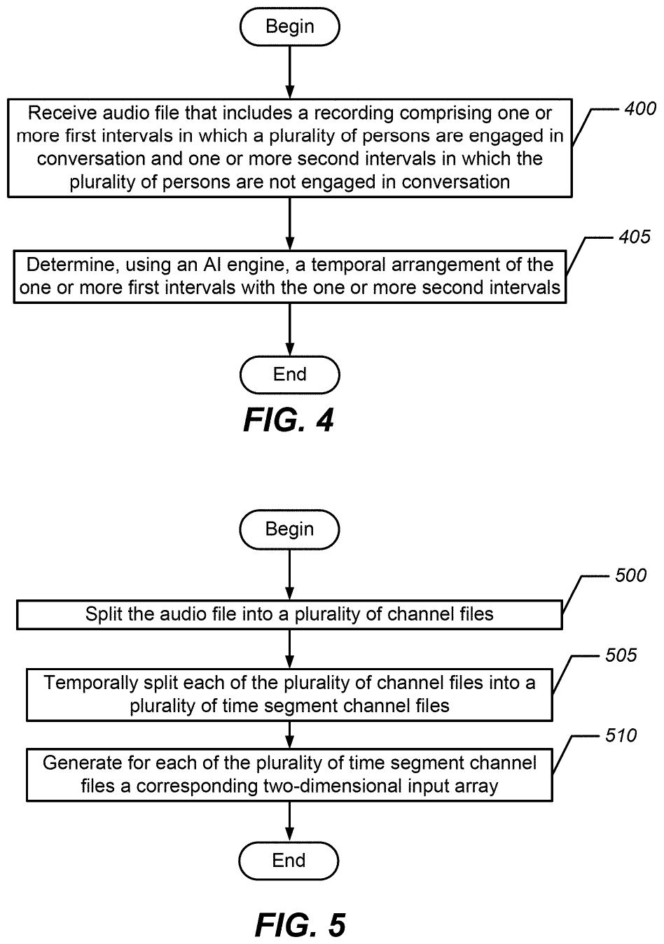

FIGS. 4-7 are flowcharts that illustrate operations of the AI assisted audio recording analysis system for determining when two people are talking, in accordance with some embodiments of the inventive concept. Referring now to FIG. 4, operations begin at block 400 where an audio file is received that includes a recording comprising one or more first intervals in which a plurality of persons are engaged in conversation and one or more second intervals in which the plurality of persons are not engaged in conversation. The AI engine 145 including the artificial neural network 210 may be used to determine a temporal arrangement of the one or more first intervals with the one or more second intervals.

Referring now to FIG. 5, in some embodiments, the audio file may be split using the splitting module 202 into a plurality of channel files corresponding to, for example, the plurality of persons at block 500. The audio file may be further temporally split using the splitting module 202 into a plurality of time segment channel files at block 505. A two-dimensional input array may be generated at block 510 for each of the plurality of time segment channel files. As described above, the frequency analysis module 205 may be used to generate the two-dimensional input array for each of the plurality of time segment channel files. The two-dimensional input array may comprise a spectrogram or a representation of an image of a spectrogram for each of the plurality of time segment channel files.

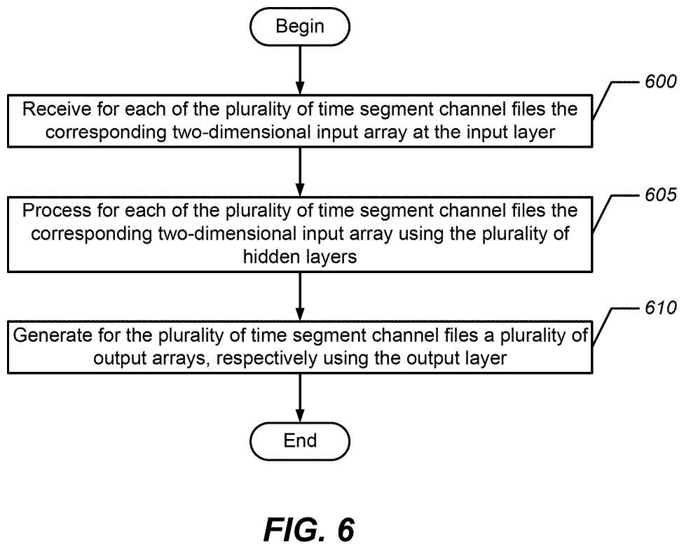

Referring now to FIG. 6, the artificial neural network 210 may receive each of the plurality of time segment channel files the corresponding two-dimensional input array at the input layer 220 at block 600. These time segment channel files may be processed using the hidden layers 225 at block 605 and a plurality of output arrays may be generated for the plurality of time segment channel files using the output layer at block 610.

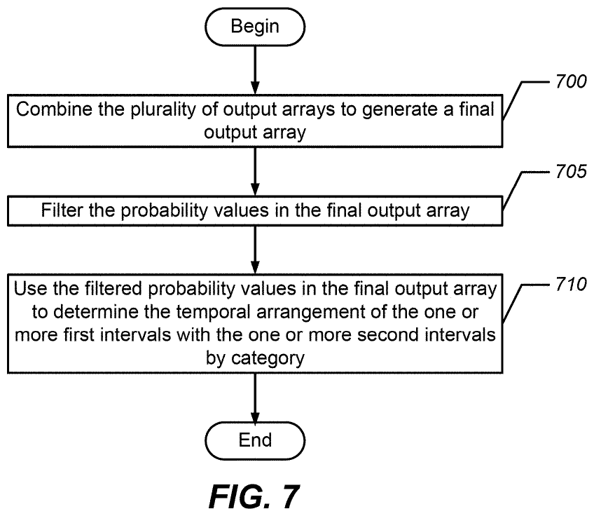

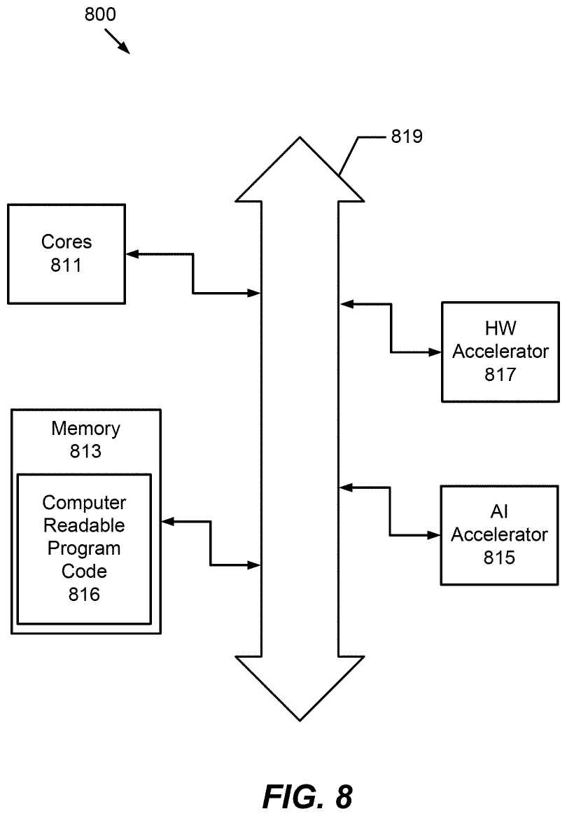

Referring now to FIG. 7, the plurality of output arrays are combined to generate a final output array at block 700. The filtering module 235 may be used to filter the probability values in the final output array at block 705 and the filtered probability values in the final output array may be used to determine the temporal arrangement of the one or more first intervals (i.e., intervals corresponding to two persons talking) and the one or more second intervals (i.e., intervals in which two persons are not talking) by category, which may include the various categories of sound during the intervals in which two persons are not talking.

Embodiments of the inventive concept may be illustrated by way of a non-limiting example of processing an audio file. Embodiments for processing an audio file may include one or more of the following operations:

Import a .wav file recording of a phone call with one or more persons on a first channel and one or more persons on a second channel.

Split the channels into two mono files, one for the agent and one for the caller.

Split each channel file into sequential audio files two seconds long, with the last file being the remainder left over, and padded with silence to make it 2 seconds if needed

For each two second file, create a spectrogram with a sampling frequency of 8000, a Tukey window with shape parameter of 0.25, an FFT length and segment length of 300, and an overlap of 200, which gives us a 2D array with a shape of (151, 158)

Use that array as an input layer for a sequential machine learning model with the following layers:

i. 2D convolution with 64 filters, kernel size of 3, with a Rectified Linear Unit activation function

ii. 2D Max Pooling operation with a pool size of (2,2)

iii. 2D convolution with 128 filters, kernel size of 3, with a Rectified Linear Unit activation function

iv. 2D Max Pooling operation with a pool size of (2,2)

v. 2D convolution with 256 filters, kernel size of 3, with a Rectified Linear Unit activation function

vi. 2D Max Pooling operation with a pool size of (2,2)

vii. Flatten operation

viii. Densely connected Neural Network with 64 units and a Rectified Linear Unit activation function

ix. Densely connected Neural Network with 4 units and a Softmax activation function

The output of the model gives us a one dimensional 4-member array with a prediction, a decimal from 0 to 1, on each of 4 categories in the following order:

i. Human Speech

ii. Silence

iii. Music

iv. Music and Human Speech combined

For the agent channel, feed each of the 2 second clip spectrograms into the model, to obtain an array where each element the prediction output from the model as described above.

That array is then fed into a model to obtain a final output of when hold music occurred during the phone call. The model contains the following steps:

i. For each set of predictions, add together the prediction values for “Music” and “Music and Human Speech combined” and append to a new array

ii. Apply a median filter to that array to smooth the results and remove potential noise

iii. Apply a high-pass filter that clamps the value of each element to 1 if above a certain threshold

iv. Apply a median filter again to smooth the results further

The output of this model is an array where each element represents 2 seconds of the original phone call and gives a value of either 0 for no hold time, or 1 for hold time.

Use the model output to obtain the final output, the start and stop of any hold time that might have happened during the phone call.

Embodiments of the inventive concept may be illustrated by way of a further non-limiting example of processing an audio file. Embodiments for processing an audio file may include one or more of the following operations:

Import a .wav file recording of a phone call with one or more persons on a first channel and one or more persons on a second channel.

Split the channels into two mono files, one for the agent and one for the caller.

Split each channel file into sequential audio files two seconds long, with the last file being the remainder of time left over, padded with silence to make it 2 seconds if needed.

For each two second file, create an image of a spectrogram with a window length of 8000, an FFT length of 128, a segment length of 8000, and an overlap of 127, which gives us a 2D array with a shape of (288,432)

Convert the RGB image of the spectrogram into a grayscale image, and then convert that into a 2D array of the spectrogram image.

Use that array as an input layer for a sequential machine learning model with the following layers:

i. 2D convolution with 64 filters, kernel size of 3, with a Rectified Linear Unit activation function

ii. 2D convolution with 64 filters, kernel size of 3, with a Rectified Linear Unit activation function

iii. 2D Max Pooling operation with a pool size of (2,2)

iv. 2D convolution with 128 filters, kernel size of 3, with a Rectified Linear Unit activation function

v. 2D convolution with 128 filters, kernel size of 3, with a Rectified Linear Unit activation function

vi. Global Average Pooling operation with a pool size of (2,2)

vii. Densely connected Neural Network with 4 units and a Softmax activation function

The output of the model gives us a one dimensional 4-member array with a prediction, a decimal from 0 to 1, on each of 4 categories in the following order:

i. Human Speech

ii. Silence

iii. Music

iv. Music and Human Speech combined

For the agent channel, feed each of the 2 second clip spectrograms into this model, to obtain an array where each element is the prediction output from the model as described above.

That array is then fed into another model to obtain a final output of when hold music occurred during the phone call. The model contains the following steps:

For each set of predictions, add together the prediction values for “Music” and “Music and Human Speech combined” and append to a new array. The value will be between 0 and 1

ii. Apply a median filter to that array to smooth the results and remove potential noise

iii. Apply a high-pass filter that clamps the value of each element to 1 if above a threshold of 0.6

iv. Apply a median filter again to smooth the results further

The output of this model is an array where each element represents 2 seconds of the original phone call and gives a value of either 0 or no hold time, or 1 for hold time.

Use the model output to obtain the final output, the start and stop of any hold time that might have happened during the phone call.

FIG. 8 is a block diagram of a data processing system 800 that may be used to implement AI assisted audio recording analysis system of FIG. 1 in accordance with some embodiments of the inventive concept. As shown in FIG. 8, the data processing system 800 may include at least one core 811, a memory 813, an Artificial Intelligence (AI) accelerator 815, and a hardware (HW) accelerator 817. The at least one core 811, the memory 813, the AI accelerator 815, and the HW accelerator 817 may communicate with each other through a bus 819.

The at least one core 811 may be configured to execute computer program instructions. For example, the at least one core 811 may execute an operating system and/or applications represented by the computer readable program code 816 stored in the memory 813. In some embodiments, the at least one core 811 may be configured to instruct the AI accelerator 815 and/or the HW accelerator 817 to perform operations by executing the instructions and obtain results of the operations from the AI accelerator 815 and/or the HW accelerator 817. In some embodiments, the at least one core 811 may be an ASIP customized for specific purposes and support a dedicated instruction set.

The memory 813 may have an arbitrary structure configured to store data. For example, the memory 813 may include a volatile memory device, such as dynamic random-access memory (DRAM) and static RAM (SRAM), or include a non-volatile memory device, such as flash memory and resistive RAM (RRAM). The at least one core 811, the AI accelerator 815, and the HW accelerator 817 may store data in the memory 813 or read data from the memory 813 through the bus 819.

The AI accelerator 815 may refer to hardware designed for AI applications, such as analyzing an audio file to determine when two people are talking in accordance with embodiments described herein. The AI accelerator 815 may generate output data by processing input data provided from the at least one core 815 and/or the HW accelerator 817 and provide the output data to the at least one core 811 and/or the HW accelerator 817. In some embodiments, the AI accelerator 815 may be programmable and be programmed by the at least one core 811 and/or the HW accelerator 817. The HW accelerator 817 may include hardware designed to perform specific operations at high speed. The HW accelerator 817 may be programmable and be programmed by the at least one core 811.

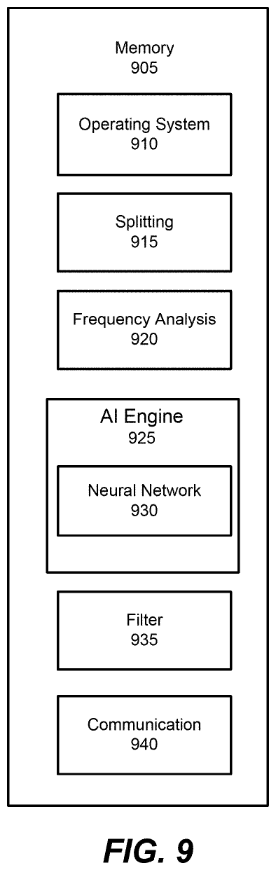

FIG. 9 illustrates a memory 905 that may be used in embodiments of data processing systems, such as the AI assisted audio recording analysis system of FIG. 1 and the data processing system 800 of FIG. 8, respectively, to facilitate operation of the AI server 140/AI engine module 145 and the interface server 130/audio file interface module 135 according to some embodiments of the inventive concept. The memory 1105 is representative of the one or more memory devices containing the software and data used for facilitating operations of the AI assisted audio recording analysis system of FIG. 1 as described herein. The memory 905 may include, but is not limited to, the following types of devices: cache, ROM, PROM, EPROM, EEPROM, flash, SRAM, and DRAM. As shown in FIG. 9, the memory 905 may contain four or more categories of software and/or data: an operating system 910, a splitting module 915, a frequency analysis module 920, an AI engine 925, a filter module 935, and a communication module 940. In particular, the operating system 910 may manage the data processing system's software and/or hardware resources and may coordinate execution of programs by the processor.

The splitting module 915 may be configured to perform one or more operations described above with respect to the splitting module 202 and the flowcharts of FIGS. 4-7. The frequency analysis module 920 may be configured to perform one or more operations described above with respect to the frequency analysis module 205 and the flowcharts of FIGS. 4-7. The AI engine 925 may include an artificial neural network module 930 and may be configured to perform one or more operations described above with respect to the neural network 210 of FIGS. 2 and 3 and the flowcharts of FIGS. 4-7. The filter module 935 may be configured to perform one or more operations described above with respect to the filtering module 235 and the flowcharts of FIGS. 4-7. The communication module 940 may be configured to facilitate communication between the interface server 130 and the recording server 105, for example.

Although FIGS. 8 and 9 illustrate hardware/software architectures that may be used in data processing systems, such as the AI assisted audio recording analysis system of FIG. 1 and the data processing system 800 of FIG. 8 in accordance with some embodiments of the inventive concept, it will be understood that embodiments of the present inventive concept are not limited to such a configuration but is intended to encompass any configuration capable of carrying out operations described herein.

Computer program code for carrying out operations of data processing systems described above with respect to FIGS. 1- 9 may be written in a high-level programming language, such as Python, Java, C, and/or C++, for development convenience. In addition, computer program code for carrying out operations of the present invention may also be written in other programming languages, such as, but not limited to, interpreted languages. Some components or routines may be written in assembly language or even micro-code to enhance performance and/or memory usage. It will be further appreciated that the functionality of any or all of the program components may also be implemented using discrete hardware components, one or more application specific integrated circuits (ASICs), or a programmed digital signal processor or microcontroller.

Moreover, the functionality of the AI assisted audio recording analysis system of FIG. 1 and the data processing system 800 of FIG. 8 may each be implemented as a single processor system, a multi-processor system, a multi-core processor system, or even a network of stand-alone computer systems, in accordance with various embodiments of the inventive concept. Each of these processor/computer systems may be referred to as a “processor” or “data processing system.”

The data processing apparatus described herein with respect to FIGS. 1-9 may be used to facilitate operation of AI assisted audio recording analysis system configured to determine when two people are talking in an audio recording according to some embodiments of the inventive concept described herein. These apparatus may be embodied as one or more enterprise, application, personal, pervasive and/or embedded computer systems and/or apparatus that are operable to receive, transmit, process and store data using any suitable combination of software, firmware and/or hardware and that may be standalone or interconnected by any public and/or private, real and/or virtual, wired and/or wireless network including all or a portion of the global communication network known as the Internet, and may include various types of tangible, non-transitory computer readable media. In particular, the memory 905 when coupled to a processor includes computer readable program code that, when executed by the processor, causes the processor to perform operations including one or more of the operations described herein with respect to FIGS. 1-8.

Some embodiments of the inventive concept may provide an AI assisted audio recording analysis system that may determine the temporal arrangement of intervals when two people are talking along with those intervals when two people are not talking. The intervals when two people are talking may be further categorized by their type, such as silence, music, and the like. These categorizations may be used for various applications, such as compiling metrics for analyzing calls to a business or call center. The categorizations may also be used to filter out unwanted content, e.g., time intervals when two people are not engaged in conversation, and use the filtered audio file for further processing, such as applying a natural language processor thereto to obtain the substantive content of the conversation or using the content where two people are engaged in conversation for training an AI system on a particular subject area.

Further Definitions and Embodiments:

In the above description of various embodiments of the present inventive concept, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present inventive concept. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

In the above-description of various embodiments of the present inventive concept, aspects of the present inventive concept may be illustrated and described herein in any of a number of patentable classes or contexts including any new and useful process, machine, manufacture, or composition of matter, or any new and useful improvement thereof. Accordingly, aspects of the present inventive concept may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present inventive concept may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

The description of the present inventive concept has been presented for purposes of illustration and description, but is not intended to be exhaustive or limited to the inventive concept in the form disclosed. Many modifications and variations will be apparent to those of ordinary skill in the art without departing from the scope and spirit of the inventive concept. The aspects of the inventive concept herein were chosen and described to best explain the principles of the inventive concept and the practical application, and to enable others of ordinary skill in the art to understand the inventive concept with various modifications as are suited to the particular use contemplated.

What is claimed is:

1. A method, comprising:
receiving an audio file that includes a recording comprising one or more first intervals in which a plurality of persons is engaged in conversation and one or more second intervals in which the plurality of persons are not engaged in conversation; and
determining, using an artificial intelligence engine, a temporal arrangement of the one or more first intervals with the one or more second intervals.

2. The method of claim 1, wherein each of the one or more first intervals is categorized as a first interval type; and
wherein each of the one or more second intervals is categorized as one of a plurality of second interval types.

3. The method of claim 2, wherein the first interval type comprises a human speech interval; and
wherein the plurality of second interval types comprises a silence interval, a music interval, and a music and human speech combined interval.

4. The method of claim 3, wherein determining the temporal arrangement of the one or more first intervals with the one or more second intervals comprises:
determining, using the artificial intelligence engine, the temporal arrangement of the one or more first intervals with the one or more second intervals by category;
wherein the method further comprises:
reporting the temporal arrangement of the one or more first intervals with the one or more second intervals by category.

5. The method of claim 4, further comprising:
determining a portion of the audio file that is categorized as the human speech interval;
determining a portion of the audio file that is categorized as the silence interval;
determining a portion of the audio file that is categorized as the music interval; and/or
determining a portion of the audio file that is categorized as the music and human speech combined interval.

6. The method of claim 4, wherein determining, using the artificial intelligence engine, the temporal arrangement of the one or more first intervals with the one or more second intervals comprises:
splitting the audio file into a plurality of channel files respectively corresponding to the plurality of persons engaged in conversation;
temporally splitting each of the plurality of channel files into a plurality of time segment channel files; and
generating, for each of the plurality of time segment channel files, a corresponding two-dimensional input array.

7. The method of claim 6, wherein the corresponding two-dimensional input array comprises a spectrogram of a respective one of the plurality of time segment channel files.

8. The method of claim 6, wherein the corresponding two-dimensional input array comprises a representation of an image of a spectrogram of a respective one of the plurality of time segment channel files.

9. The method of claim 6, wherein the artificial intelligence engine comprises a multi-layer artificial neural network including an input layer, a plurality of hidden layers, and an output layer, the method further comprising:
receiving, for each of the plurality of time segment channel files, the corresponding two-dimensional input array at the input layer;
processing, for each of the plurality of time segment channel files, the corresponding two-dimensional input array using the plurality of hidden layers; and
generating, for the plurality of time segment channel files, a plurality of output arrays, respectively, using the output layer.

10. The method of claim 9, wherein the plurality of hidden layers comprises at least one convolution layer, at least one max pooling layer, at least one flatten layer, and at least one densely connected layer.

11. The method of claim 10, wherein the at least one convolution layer uses a Rectified Linear Unit (ReLU) activation function and the at least one densely connected layer uses a ReLU activation function or a Softmax activation function.

12. The method of claim 9, wherein each of the plurality of output arrays comprises a probability value for each of the first interval type and the plurality of second interval types occurring during a respective one of the plurality of time segment channel files.

13. The method of claim 12, wherein determining, using the artificial intelligence engine, the temporal arrangement of the one or more first intervals with the one or more second intervals by category comprises:
combining the plurality of output arrays corresponding to each of the plurality of time segment channel files across the plurality of channel files to generate a final output array containing probability values for each of the first interval type and the plurality of second interval types occurring during time intervals respectively corresponding to the plurality of time segment channel files;
filtering the probability values in the final output array; and
using the filtered probability values in the final output array to determine the temporal arrangement of the one or more first intervals with the one or more second intervals by category.

14. A system, comprising:
a processor; and
a memory coupled to the processor and comprising computer readable program code embodied in the memory that is executable by the processor to perform operations comprising:
receiving an audio file that includes a recording comprising one or more first intervals in which a plurality of persons is engaged in conversation and one or more second intervals in which the plurality of persons are not engaged in conversation; and
determining, using an artificial intelligence engine, a temporal arrangement of the one or more first intervals with the one or more second intervals.

15. The system of claim 14, wherein each of the one or more first intervals is categorized as a first interval type; and
wherein each of the one or more second intervals is categorized as one of a plurality of second interval types.

16. The system of claim 15, wherein the first interval type comprises a human speech interval; and
wherein the plurality of second interval types comprises a silence interval, a music interval, and a music and human speech combined interval.

17. The system of claim 16, wherein determining the temporal arrangement of the one or more first intervals with the one or more second intervals comprises:
determining, using the artificial intelligence engine, the temporal arrangement of the one or more first intervals with the one or more second intervals by category;
wherein the operations further comprise:
reporting the temporal arrangement of the one or more first intervals with the one or more second intervals by category.

18. A computer program product, comprising:
a non-transitory computer readable storage medium comprising computer readable program code embodied in the medium that is executable by a processor to perform operations comprising:
receiving an audio file that includes a recording comprising one or more first intervals in which a plurality of persons is engaged in conversation and one or more second intervals in which the plurality of persons are not engaged in conversation; and
determining, using an artificial intelligence engine, a temporal arrangement of the one or more first intervals with the one or more second intervals.

19. The computer program product of claim 18, wherein each of the one or more first intervals is categorized as a first interval type; and
wherein each of the one or more second intervals is categorized as one of a plurality of second interval types.

20. The computer program product of claim 19, wherein the first interval type comprises a human speech interval;
wherein the plurality of second interval types comprises a silence interval, a music interval, and a music and human speech combined interval; and
wherein determining the temporal arrangement of the one or more first intervals with the one or more second intervals comprises:
determining, using the artificial intelligence engine, the temporal arrangement of the one or more first intervals with the one or more second intervals by category;
wherein the operations further comprise:
reporting the temporal arrangement of the one or more first intervals with the one or more second intervals by category.
